(19) United States
(12) Patent Application Publication
(10) Pub. No.: US 2005/0278694 A1
(43) Pub. Date: Dec. 15, 2005

(54) Describing Runtime Components of a Solution for a Computer System

(75) Inventors: Nicholas D. Butler, Romsey, Hampshire (GB); Christine M. Draper, Basingstoke, Hampshire (GB); John W. Sweitzer, Austin, TX (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINE CORPORATION, Armonk, NY (US)

(21) Appl. No.: 10/904,436

(22) Filed: Nov. 10, 2004

(30) Foreign Application Priority Data
Nov. 15, 2003 (GB) 0326667.3
Nov. 15, 2003 (GB) 0326668.1
Apr. 13, 2004 (GB) 0408183.2

(51) Int. Cl. G06F 9/44

(52) U.S. Cl. 717/107; 717/104

(57) ABSTRACT

An apparatus for describing runtime components of a solution on a computer system comprises a description of the software components of a solution instance comprising relationships between the software components. The description may be a logical description independent of a particular physical instantiation of the solution instance.

### BACKGROUND OF THE INVENTION

This invention relates to the field of describing runtime components of a solution for a computer system, and more particularly, to describing runtime components of a solution and how to manage the solution.

Many business computer applications are very complex and involve many runtime software components. Managing and monitoring the solution involves understanding all the relevant resources and how they relate to each other. For example, to determine whether the solution is running correctly requires the aggregation of the status of these manageable resources and understanding which resources are dependent on which other resources.

### BRIEF SUMMARY OF THE INVENTION

According to one aspect of the present invention, an apparatus for describing runtime components of a solution on a computer system comprises a description of the software components of a solution instance comprising relationships between the software components, wherein the description is a logical description independent of a particular physical instantiation of the solution instance.

According to another aspect of the present invention, a method for describing runtime components of a solution on a computer system comprises describing the software components of a solution instance comprising relationships between the software components, wherein the description is a logical description independent of a particular physical instantiation of the solution instance.

According to yet another aspect of the present invention, a computer program product for describing runtime components of a solution on a computer system, the computer program product comprises a computer readable medium having computer readable program code embodied therein. The computer readable program code comprises computer readable program code configured to describe the software components of a solution instance comprising relationships between the software components, wherein the description is a logical description independent of a particular physical instantiation of the solution instance.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a schematic diagram of an installable unit and examples of installable units at different levels of a resource stack;

FIG. 2 is a block diagram of the contents of an installable unit shown in FIG. 1;

FIG. 3 is a diagram of the sequence of operations an installer may perform when installing an installable unit of FIG. 1;

FIG. 4 is a block diagram of a solution module package;

FIG. 5 is a top level structure of a solution module definition of a solution module package of FIG. 4;

FIG. 6 is a schematic diagram of the overall process of developing and deploying a solution; and

FIG. 7 is an example showing a solution module package and the mapping of a logical topology to a physical topology;

FIG. 8 is a schematic representation of a solution instance in the runtime of a solution in accordance with the present invention;

FIG. 9 is a solution level view of a computer system in accordance with the present invention;

FIG. 10 is a block diagram of the components of a solution together with a solution specification sheet and solution hosting environment in accordance with the present invention;

FIG. 11 is a block diagram of the solution specification sheet of FIG. 10 showing how it relates to a solution module definition of FIGS. 4 and 5; and

FIG. 12 is a block diagram of one implementation of a solution hosting environment of FIG. 10 that can interpret a solution specification sheet.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

A software component to be installed is packaged as an installable unit, which contains the “code” to be installed, together with a descriptor containing the information needed to install it. Installable units (IUs) are installed not into the operating system, but rather into a corresponding target hosting environment. For example, for a J2EE application (Java is a trademark of Sun Microsystems, Inc. in the United States, other countries, or both) the installer knows that it is installing this into a WebSphere application server (WebSphere is a trademark of International Business Machines Corporation in the United States, other countries, or both) WebSphere is a trademark of International Business Machines Corporation in the United States, other countries, or both) rather than into the operating system.

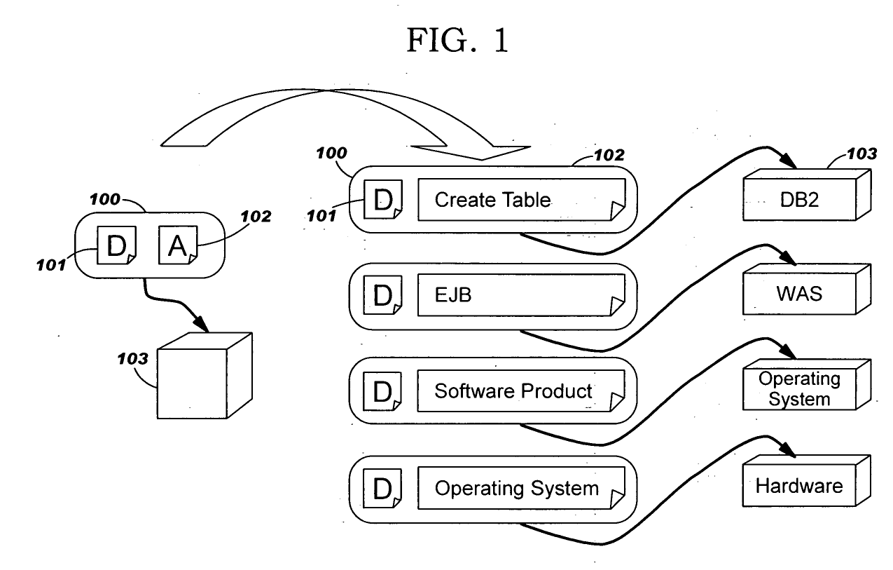

FIG. 1 shows an installable unit (IU) 100 which is a package structure, for example, like a JAR (Java Archive) file with a descriptor and some collection of files. The IU 100 includes a descriptor 101 which describes the content of the IU and an artifact 102 that can be installed. The IU 100 is installed into an appropriate hosting environment 103 or container that can accept an artifact 102. In general, things that get installed or created can fit into the installable unit—hosting environment pattern.

This design pattern can be used at all levels of the resource stack as shown in FIG. 1. An artifact 102 can be any software component from a simple data file to an operating system and, correspondingly, a hosting environment 103 can range from a database in which a data file is to be installed to hardware on which an operating system is to be installed.

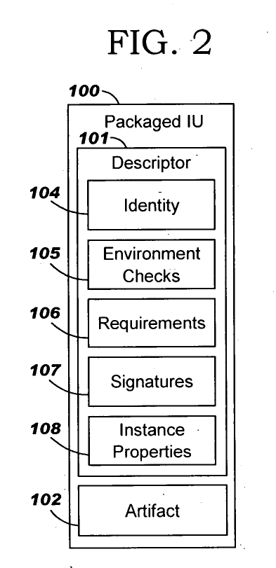

FIG. 2 illustrates one implementation of the concept of an installable unit 100. The descriptor 101 includes:

Identity 104—The unique identifier for this component including manufacturer, version, compatibility with other versions, etc.

Environment checks and Requirements 105, 106—These describe the required properties and conditions of the hosting environment for this component.

Signatures 107—These describe how to determine if an installable unit is installed.

Instance properties 108—Key properties relating to the install,such as install path, port number.

In prior solutions, dependencies can only be described in terms of properties of the operating system, such as disk space, memory capacity, etc, or using custom pieces of code that can perform checks on the target hosting environment and which are run via the operating system. When the installer knows the target hosting environment, these dependencies can be described in terms of properties of the target hosting environment. The relevant properties of the hosting environment need to be exposed to allow this, but this is once per hosting environment, rather than per installable unit and in many cases these will already be available through existing management interfaces.

The installer does not need to understand the internals of an artifact, simply the parameters that are required to install it. The descriptor provides all the information needed by an installer, leaving the artifact itself as an opaque object. The only responsibility that the installer has is to make it available to the install interface on the target hosting environment.

The installer program can implement a generic install mechanism that can be applied to any artifact type and any hosting environment. The hosting environment is responsible for knowing how to install its artifact types, and the component packaging no longer has to include anything to map the install to operating system commands.

This approach has most value when the hosting environments all provide a common set of interfaces for install, uninstall, dependency checking and so on. Even without this, the fact that all things that must be deployed are described in a common way, with common description of their requirements their environment is still of value as it allows installers to reason about all artifact types in a common way.

The details of exactly what information is stored, or how, is not important to this disclosure. The descriptor might contain a single installable unit, or it might allow multiple installable units to be aggregated into a single package.

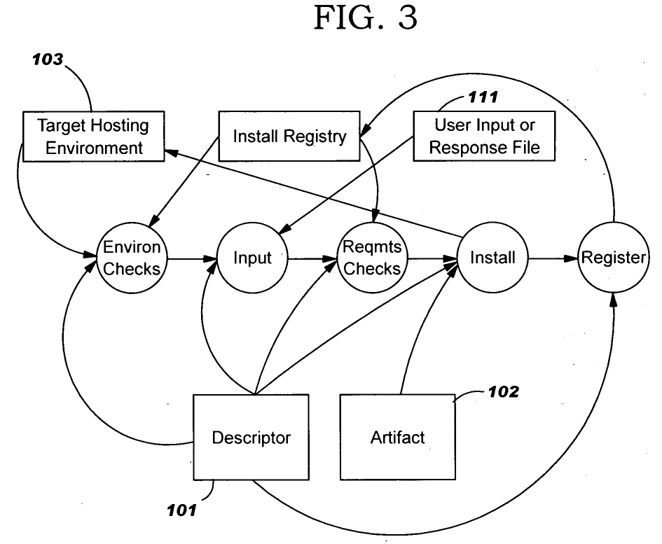

FIG. 3 shows the sequence of operations 110 that an installer may perform when installing an installable unit 100. The installer may choose the target hosting environment 103 by a number of different means, including:

The installer presents the user with a list of all hosting environments and lets them choose 111. In this case, it is possible for the user to select one that does not support the given artifact type.

The descriptor 101 identifies the type of the artifact 102. The installer looks in a registry of hosting environments to find one or more that says that it hosts the particular artifact type—i.e. The artifact can be installed in it. The installer can then allow the user to select one (or more) from this list.

The descriptor 101 includes dependencies that describe the required hosting environment. For example, the descriptor 101 might indicate that the target hosting environment 103 must be a J2EE application server. The installer can then use this to locate an appropriate target.

This descriptor 101 shows dependencies that apply to either the immediate hosting environment of the artifact, or the operating system on which that hosting environment sits (e.g. disk space). However, there is no reason why dependencies outside this scope should not be used. For example, an EAR (Enterprise Archive) file needs to be located on a WebSphere application server that is using a DB2 database, rather than any other type of database.

A description is now provided of a method and apparatus for describing and packaging solutions for a computer system. A mechanism is provided for describing the targets of a solution in terms of the requirements that each software component has on its own target hosting environment and also the requirements that the solution itself imposes.

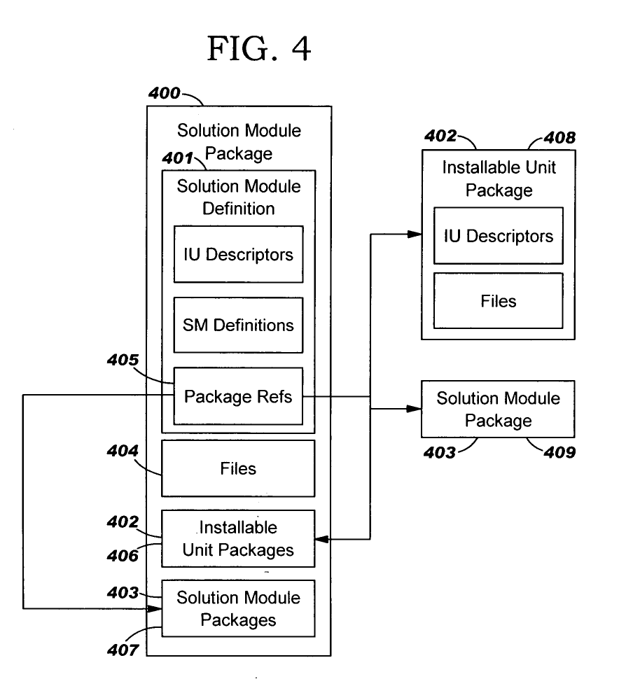

Referring to FIG. 4, a solution module (SM) 400 is provided that packages up the installable units (IUs) that are the software components that comprise a solution, as well as a descriptor 401 of that solution. The descriptor 401 of the solution is referred to as the solution module definition (SMD).

FIG. 4 shows how a solution module 400 is composed from installable units, whether these are single target installable units 402 or other multi-target solution modules 403. The composed installable units may either be defined “in-line” 404 as part of a single solution module package 400, or there may be references 405 to separately packaged installable units. The referenced installable units may either be packaged within the solution module package 406, 407, or may be external packages 408, 409.

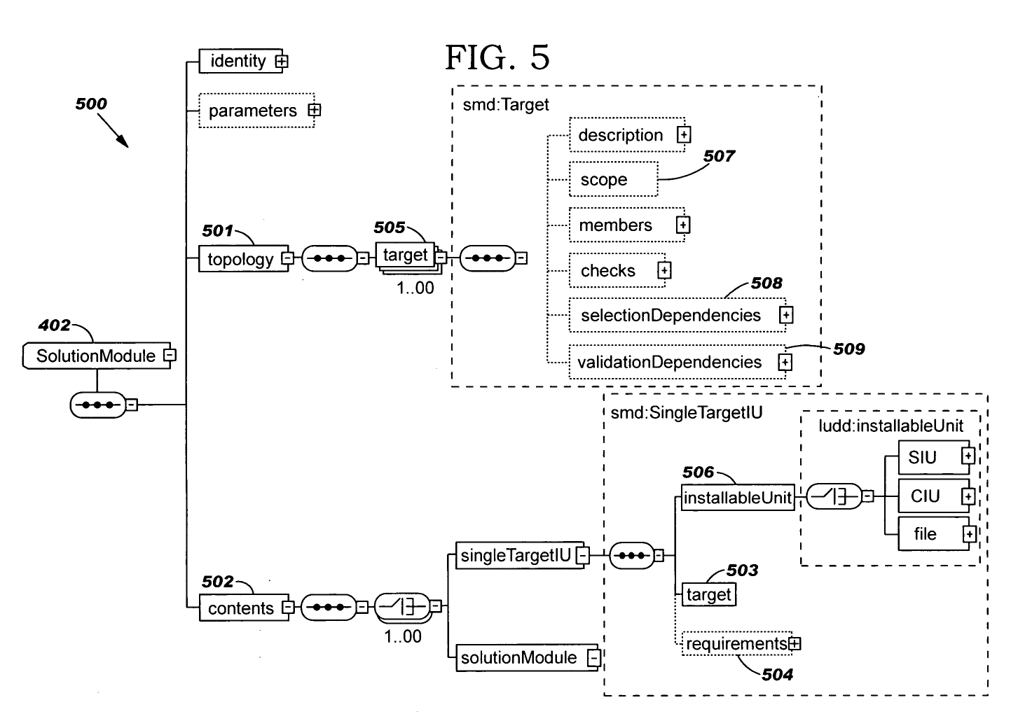

FIG. 5 shows the top level structure 500 of the solution module definition 401. The two parts of this that are important to this description are the “topology” section 501 and the “target” 503 and “requirements” 504 of the “contents” section 502.

The target elements 505 within the topology section 501 together describe the logical topology onto which the solution should be deployed. This logical topology is specified in terms of the requirements on the target hosting environments within the topology, including the relationships between them. It is also possible that the requirements may involve manageable resources that are not themselves hosting environments but which are used to establish requirements on targets. For example, locating a database that already has a particular database table within it.

The target element 503 within the content section 502 points to one of the targets in the logical topology, and specifies the target hosting environment for the associated installable unit 506. It may describe additional requirements for the installable unit. These are solution-level requirements that override or add to the requirements already defined within the installable unit.

Characteristics of the logical topology definition include:

One logical target may be mapped to multiple physical targets. A target scope statement 507 defines whether a logical target should be mapped to one, some or all of the candidate targets.

Requirements on a logical target are divided into selection requirements 508, which are used to define a candidate list of targets; and validation requirements 509, which are used to validate the selected targets.

Each installable unit may specify additional requirements 504 on the relationships between targets, or on characteristics of a target, including its properties, status and contents (e.g. the software installed into it).

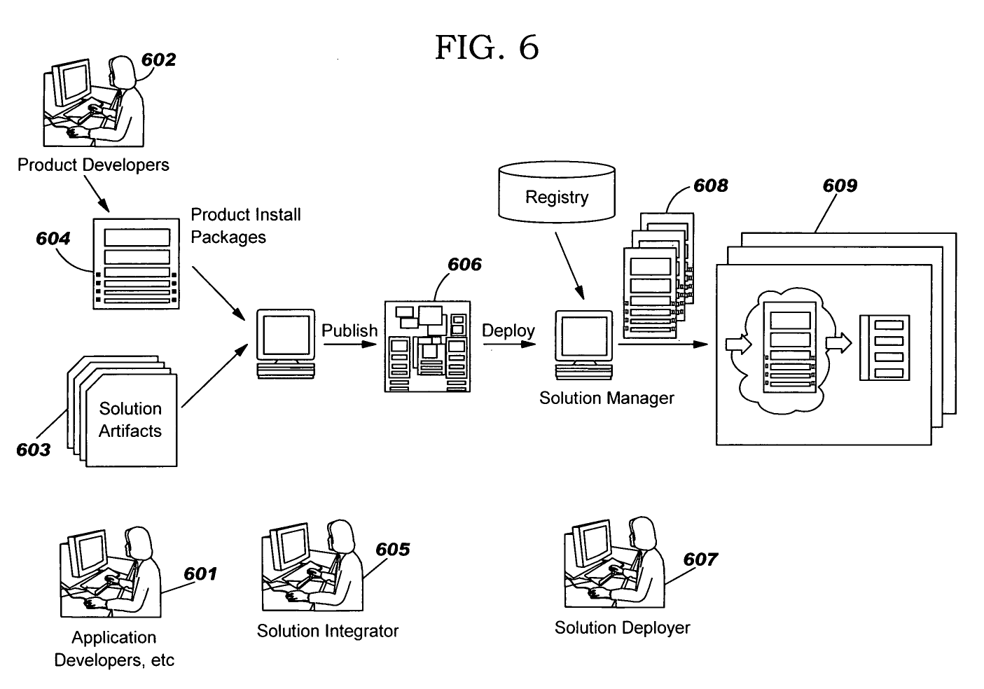

The overall process for developing and deploying a solution is described below with reference to FIG. 6. A solution is developed by application developers 601 and/or product developers 602. The application developers 601 create solution artifacts 603 which are integrated by a solution integrator 605 with product installation packages 604 developed by product developers 602.

The solution is then packaged as one or more solution module 606, at which point the logical topology is defined, and distributed to solution deployers 607. The solution deployer 607 makes installation-specific decisions about how the solution module is to be configured, and the solution deployment tooling assists in mapping the logical topology defined in the solution module onto the physical topology 608. The solution components (in the form of installable units) are then distributed and installed 609.

The described method focuses on the way the logical topology is described in the solution module definition and its use during deployment. The main way in which the logical topology is used is to support automated assistance in selecting the physical targets onto which the solution is to be deployed. Manual installation can intervene if there is an ambiguity.

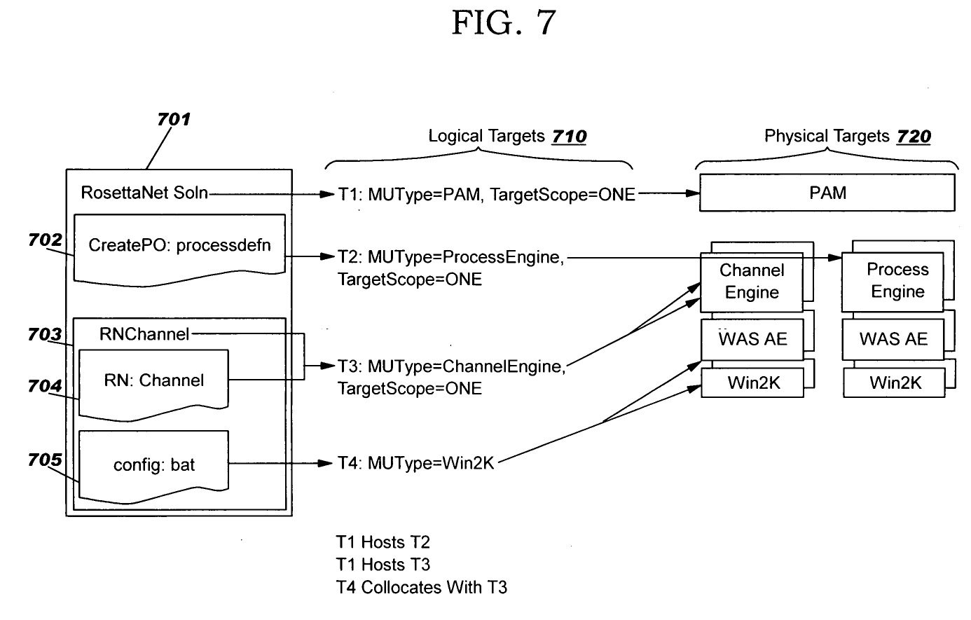

The characteristics of the way the logical topology may be mapped to a physical topology is illustrated in the following example with reference to FIG. 7. In this example, a solution 701 “RosettaNet Solution” consists of an installable unit 702 containing the “CreatePO” process definition, and an embedded solution module 703 containing a channel 704 and its configuration 705.

The elements of the logical topology 710 it is targeted at are:

T1, the B2B Gateway (PAM (Plugable Authentication Module for Linux)), which hosts multiple channel engines and process engines;

T2, one process engine within T1;

T3, all of the channel engines within T1;

T4, the operating systems on which the channel engines are located, which must be Microsoft Windows 2K (Microsoft and Windows are registered trademarks of Microsoft Corporation in the United States, other countries, or both).

The logical targets 710 are mapped to physical targets 720. A possible high-level algorithm for deploying a solution module is as follows:

Select solution module.

Analyse contents. The input is the solution module definition. The output is a list of single-target installable units, their dependencies, and their targeting requirements.

Plan deployment. This results in a list of resolved targets, identifying which artifacts are to be deployed where.

Prepare for installation. The input is the list of installable units to be deployed, the dependency information and the target information. The output is a plan to be executed. This plan might be modified by the user, for example, to add scheduling information.

Install. The input is the deployment plan. Output will typically be returned asynchronously, and is the result of the installation.

The logical topology is primarily used in the “Plan deployment” step, in order to identify candidate targets. A possible algorithm for this is as follows:

Consolidate the complete set of logical topology requirements from the solution module and all embedded and referenced solution modules and installable units:

For each target in the logical topology:
Identify candidates that match the selection requirements on that target.

This may require manual entry or selection of candidates, or an automated approach such as a search for matching targets in a registry.

For each target in the logical topology:
If the scope is “all”, select all of the candidates.
Where there are multiple candidates and the target scope is “one” or “some”, select from the list of candidates.

This might be done by a user, or automatically in accordance with some algorithm or policy.
If there are no candidates, this is an error.
Check that the validation requirements are met.

For all embedded and referenced installable units, check that the requirements associated with that installable unit are satisfied by its resolved physical target(s).

The logical topology also supports defining solution parameters whose values are dependent on target characteristics, for example, properties or status. This addresses the problem of how to allow a solution to be configured in a context-sensitive manner. In a solution module, a parameter may be defined and associated with a property on a logical target. This parameter may then be used within the solution module, e.g. the parameter is associated with the property on a message queue that indicates which IP port the queue is receiving messages, and that is then used in the solution module when installing a component that will be sending messages to that queue.

A description is now provided of a method and apparatus for describing runtime components of a solution and their runtime dependencies in accordance with the present invention. One of the basic assumptions underlying this invention is that everything in a solution is a manageable resource. Any component in a system can be described and managed in a uniform way, at all levels of the software (and, potentially, the hardware) stack.

In this way the following are manageable resources:

The operating system and the elements inside the operating system such as file systems and processes;

The web application server, database server or a queue manager and the elements inside them such as J2EE applications, database tables, queues; and

The applications or solutions that run on the middleware and which may be composed of the elements such as J2EE applications, databases, etc.

The described method and apparatus is concerned with the composition of individual manageable resources into solutions, and how the runtime solutions can be managed. However, the same concepts could be applied at any level of the stack where an aggregate or group resource is composed of multiple individual resources for the purposes of management. For example, for managing server clusters.

The description provided above in relation to FIGS. 1 to 3 relates to how components of a solution can be installed. The description provided in relation to FIGS. 4 to 7 describes how solutions can be packaged for deployment and subsequent change management. This method differs in that it applies to the runtime management of a solution and how to monitor and administer the various runtime components of a solution. The solution may or may not have been installed via the mechanism described above in relation to FIGS. 1 to 7.

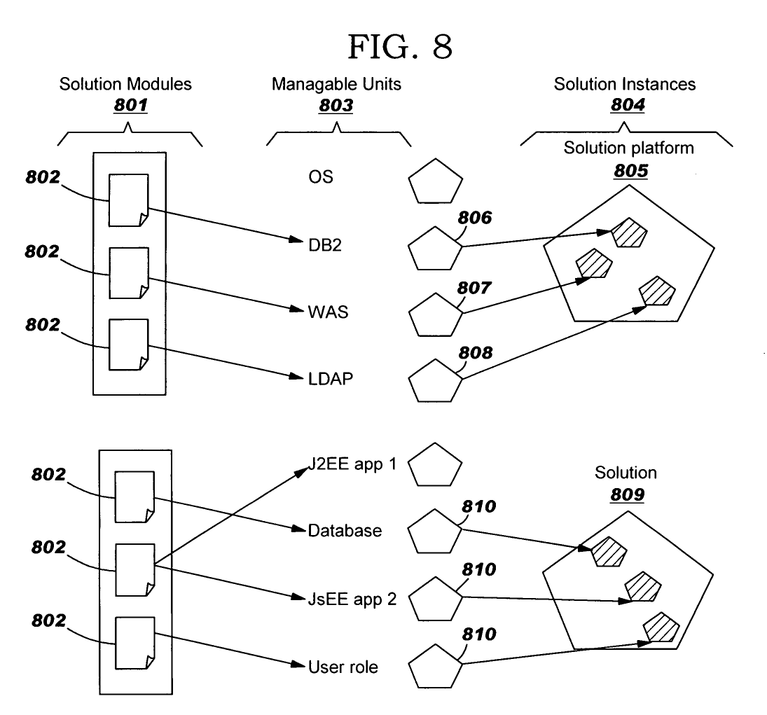

Referring to FIG. 8, a solution module as described in relation to FIG. 4 may be used to instantiate manageable resources which may be part of a “solution instance”. Two forms of solution module 801 are shown in FIG. 8 which package the software components 802 of a solution. The software components 802 create the manageable units 803 for each instance of the solution.

A “solution instance” 804 is defined as a manageable resource that federates others together, and represents a higher-level entity that a user wants to monitor and control (for example, controls such as start, stop). Both solution modules 801 and solution instances 804 may be used at various levels of the software stack.

For example, a solution module may be used to create a “solution platform” 805, which may be a combination of a database 806, an application server 807, and a directory 808 configured together to perform as an e-business server. As a second example, a solution instance may be used to describe the application components 810 that provide one of the “solutions” 809 running on that solution platform 805.

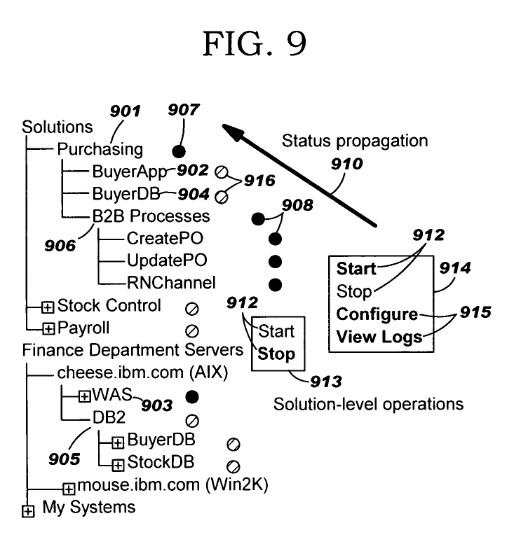

Referring to FIG. 9, an illustration is provided of how a solution instance 804 may be used to give administrators a solution-level view on the IT system. In this example, a purchasing solution 901 is composed of a buyer application 902 running on a WebSphere application server 903; a buyer database 904 running in a DB2 database 905; and a set of channels and processes 906 running on a B2B Gateway.

The administrator can see that the purchasing solution 901 has an overall status of “yellow” (shown as diagonal hatching) 907. The buyer application 902 and the buyer database 904 are operating normally as shown in “green” (shown as vertical hatching) 916. The B2B processes 906 are not operating and have a status of “red” (shown as checked hatching) 908. This results in an overall status of “yellow” for the purchasing solution 901 as the function of the overall solution is degraded but not completely stopped. If the buyer application 902 or the buyer database 904 were not operating, the overall solution status would be “red”.

It can be seen from FIG. 9, that status propagation 910 is up the component levels. Status propagation is one of the purposes of defining a solution instance. Another purpose is to support solution-level operations such as starting or stopping an entire solution. FIG. 9 illustrates that there are operations 912 (e.g. start, stop) that may be available at the level of a solution 913 or on individual solution components 914. There are other, additional operations 915 (e.g. view logs, configure) that may only be available on individual components 914.

The key part of this description relates to how the information required to define and manage a solution instance is established in the runtime system, without requiring the writing of code for each solution instance. The concept is that a “solution specification sheet” (SSS) is defined when the solution is developed. This solution specification sheet contains the information which describes the components of the solution, the relationships between them, and the rules or constraints which determine how they should be managed. However, the solution specification sheet (like the solution module) is independent of any particular physical instantiation of the solution instance. Instead, it may be used either as part of the deployment process, or via a process of assisted discovery, to create a runtime representation of the solution instance which allows it to be managed.

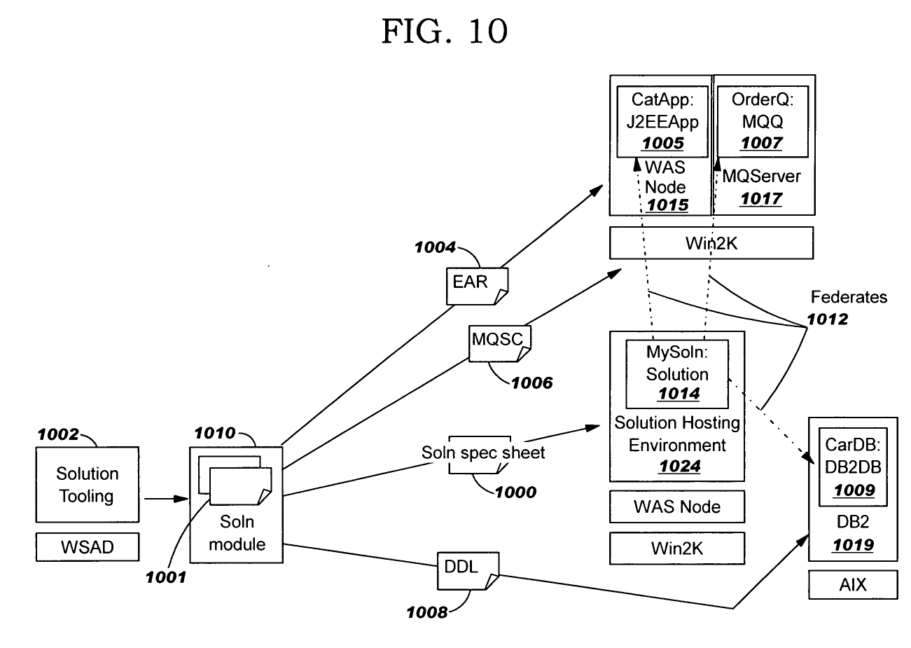

FIG. 10 illustrates how a solution specification sheet 1000 can be used as part of the deployment process to create a manageable solution instance. In the example shown in this diagram, solution tooling 1002 is used to create the artifacts 1001 in a solution, including:

An EAR file 1004 which contains a J2EE catalog application 1005;

A queue definition file 1006 which contains the definition of a queue 1007 to be used for orders;

A DDL (data definition language) file 1008 which contains the definition of the catalog database 1009.

These artifacts 1001 are packaged and defined in a solution module 1010. The solution tooling 1002 is also used to construct a solution specification sheet 1000, which describes the J2EE application 1005, queue 1007 and database 1009 and how the catalog solution (MySoln) 1014 federates 1012 these together. Although the example shows a one to one correspondence between artifacts 1001 in the solution module and components 1005, 1007, 1009 of a solution instance, this is not required. One artifact may cause the instantiation of multiple manageable resources. Furthermore, not all of those resources may be part of the solution instance. A solution instance may federate resources that are created by multiple solution modules or by other means.

During deployment, the artifacts 1001 in the solution module 1010 are targeted at and deployed to their receiving hosting environments. In this example, namely a WAS server 1015 for the EAR file 1004, an MQ server 1017 for the queue definition 1006, and a DB2 instance 1019 for the DDL file 1008.

The solution specification sheet 1000 is also targeted at a receiving environment that is capable of interpreting it. This environment has been called a “solution hosting environment” (SHE) 1024. As well as receiving the solution specification sheet 1000, the solution hosting environment 1024 also receives the list of target hosting environments from the deployment, and it uses this information in conjunction with the solution specification sheet 1000 to establish the identity of the components that are part of the solution instance. The solution specification sheet 1000 is deployed after the other solution artifacts 1001, so that the solution hosting environment 1024 can use the information provided to it to go out and automatically discover the manageable resource instances in the target hosting environments.

A similar process may be used for existing solutions, or ones which are not deployed using a solution module. In this case, instead of the deployment application constructing the list of target hosting environments that the solution hosting environment can use to discover the resource instances, this information must be provided by another means. One approach would be for the user to enter the list of hosting environments. Another would be to use information in the solution specification sheet to identify candidate hosting environments by searching in a registry or some other source of information, and then allowing a user to identify the actual hosting environments.

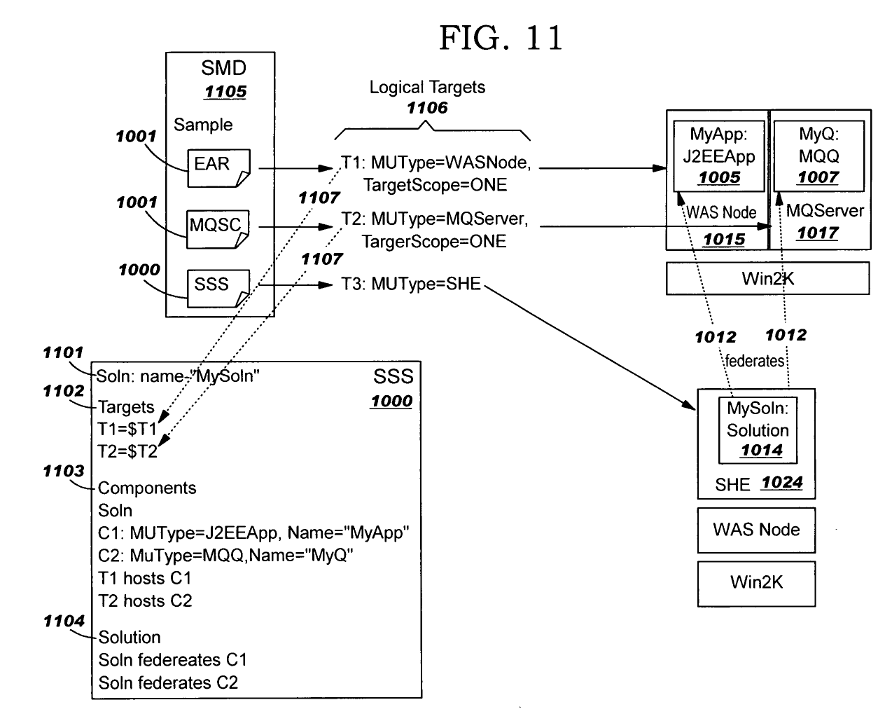

FIG. 11 illustrates a solution specification sheet 1000 in more detail. The sheet 1000 includes the following:

An identity of the solution instance 1101;

A set of target hosting environments 1102 relevant to the solution instance definition;

A set of components 1103 relevant to the solution instance definition; and

Solution characteristics 1104, such as relationships between the components.

In FIG. 11, a solution module definition 1105 as described in FIGS. 4 and 5 is shown which defines the artifacts 1001 of the solution module 1010 and the solution specification sheet 1000. The logical targets 1106 of the artifacts 1101 are defined and passed 1107 as parameters 1102 to the target solution hosting environment 1024 of the solution specification sheet 1000.

FIG. 11 shows how the logical targets 1106 defined in the solution module definition 1105 and whose runtime relationships are defined in the solution specification sheet 1000 map to the hosting environments 1015, 1017 of the artifacts 1005, 1007 and the solution hosting environment 1024 of the solution instance 1014 which federates 1012 together components 1005, 1007 with the hosting environments 1015, 1017.

Important characteristics of the solution specification sheet 1000 include the following:

The logical targets may map to multiple physical targets;

The logical components are described by defining the requirements on the components (e.g. their type, name or other characteristics, including required relationships to other components, such as the host's relationships in FIG. 10);

Each logical component may map to multiple physical components;

The solution definition asserts the existence of relationships that define the solution instance and should be used to manage it (e.g. the federate relationships in FIG. 10). It may also assert additional information about the solution dependencies and how the solution should be managed, for example to identify which components should be stopped or started when the solution is stopped or started, and in what order; or to indicate how status should be propagated.

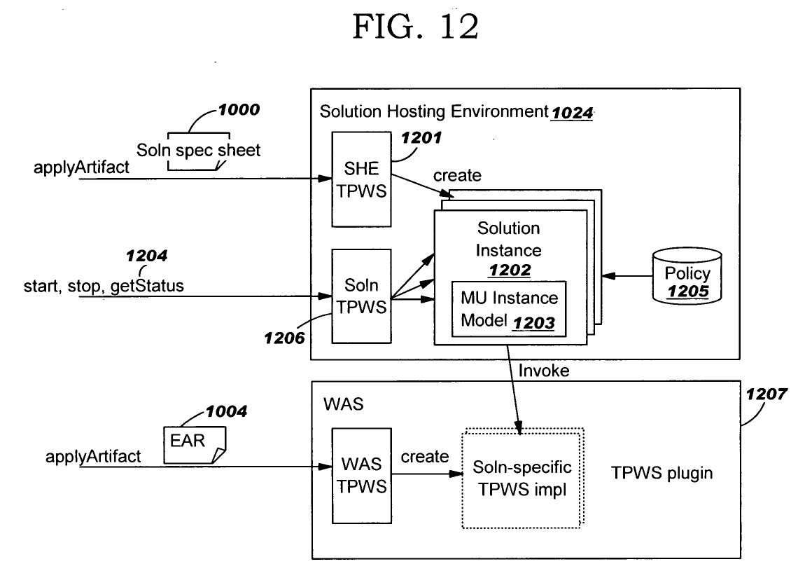

FIG. 12 illustrates one possible implementation of a solution hosting environment 1024 that can interpret a solution specification sheet 1000. The solution specification sheet 1000 is “installed” into the solution hosting environment 1024 using a standard operation, as part of the normal deployment process.

In this specific example, these operations are provided through a “touchpoint webservice” (TPWS) 1201. Installing the solution specification sheet 1000 causes the instantiation of a data object 1202 representing a solution instance within the solution hosting environment 1024. This data object 1202 includes a model 1203 of the manageable resource instances that comprise the solution.

For managing the solution instances 1202, the solution hosting environment 1024 exposes a set of standard operations 1204, for example, start, stop, getStatus. These operations 1204 can be applied to any solution instance 1202. The standard operations 1204 are provided through a TPWS 1206.

To implement these operations 1204, the solution hosting environment 1024 makes use of:

The manageable resource model 1203 that corresponds to the specific solution instance 1202;

Policy information 1205 that determines how operations 1204 should be applied; and

Optionally, executable or interpretable definitions (e.g. Code plugins or rules) which may have been provided for a specific solution instance 1207.

The above description shows how the runtime components of a computer solution can be described by a developer of a solution and managed by a user of the solution. The solution specification sheet provides a description of the components of the solution and their interrelationships. A solution hosting environment hosts the solution specification sheet and federates the resources used by the components described in the solution specification sheet. The solution specification sheet is used to describe a solution instance which can be displayed to a user as shown in FIG. 9 enabling management of the components of the solution.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “he” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. An apparatus for describing runtime components of a solution on a computer system, comprising:
a description of the software components of a solution instance comprising relationships between the software components;
wherein the description is a logical description independent of a particular physical instantiation of the solution instance.

2. An apparatus as claimed in claim 1, further comprising a hosting environment that interprets the description to provide management for the solution instance described by the description automatically.

3. An apparatus as claimed in claim 2, wherein the hosting environment comprises a receiving device that receives a list of target hosting environments for the described software components.

4. An apparatus as claimed in claim 2, wherein the hosting environment comprises descriptions for a plurality of solution instances in the form of data objects, each data object comprising a model of manageable resource instances that comprise the solution.

5. An apparatus as claimed in claim 2, wherein the hosting environment comprises a set of operations which can be applied to a solution instance.

6. An apparatus as claimed in claim 2, wherein a runtime representation of a solution instance is created using the description and hosting environment.

7. An apparatus as claimed in claim 6, wherein the representation comprises a solution level view of the computer system for a solution instance comprising status indications for the software components of the solution instance.

8. An apparatus as claimed in claim 6, wherein the representation comprises a control device that operates at the level of the solution and at individual solution components.

9. An apparatus as claimed in claim 1, wherein the description of the software components relate to any level of the software stack where a group resource is composed of multiple individual resources.

10. An apparatus as claimed in claim 1, wherein the description comprises: logical components and requirements on the components; logical target hosting environments; and a solution definition that asserts the relationships that define a solution instance.

11. An apparatus as claimed in claim 10, wherein logical components described in the description map onto one or more physical components.

12. An apparatus as claimed in claim 10, wherein logical target hosting environments map onto one or more physical target hosting environments.

13. A method for describing runtime components of a solution on a computer system, comprising:
describing the software components of a solution instance comprising relationships between the software components;
wherein the description is a logical description independent of a particular physical instantiation of the solution instance.

14. A method as claimed in claim 13 further comprising:
providing a hosting environment that interprets the description to provide management for the solution instance described by the description automatically.

15. A method as claimed in claim 14, wherein describing the software components of a solution instance comprising relationships between the software components is carried out at development of the solution and the description is installed into the hosting environment at the deployment of the solution.

16. A method as claimed in claim 14, wherein the hosting environment receives a list of target hosting environments for the described software components.

17. A method as claimed in claim 14, further comprising creating a runtime representation of a solution instance using the description and hosting environment.

18. A method as claimed in claim 17, wherein the representation comprises a solution level view of the computer system for a solution instance comprising status indications for the software components of the solution instance.

19. A method as claimed in claim 13, wherein describing the software components of a solution instance comprising relationships between the software components relate to any level of the software stack where a group resource is composed of multiple individual resources.

20. A method as claimed in claim 13, wherein describing the software components of a solution instance comprising relationships between the software components comprises describing: logical components and requirements on the components; logical target hosting environments; and a solution definition that asserts the relationships that define a solution instance.

21. A method as claimed in claim 20, wherein logical components described in the description map onto one or more physical components.

22. A method as claimed in claim 20, wherein logical target hosting environments map onto one or more physical target hosting environments.

23. A computer program product for describing runtime components of a solution on a computer system, the computer program product comprising:
a computer readable medium having computer readable program code embodied therein, the computer readable program code comprising: computer readable program code configured to describe the software components of a solution instance comprising relationships between the software components;
wherein the description is a logical description independent of a particular physical instantiation of the solution instance.
